(19) United States
(12) Patent Application Publication
(10) Pub. No.: US 2004/0139074 A1
(43) Pub. Date: Jul. 15, 2004

(54) Circuit for processing data

(76) Inventor: Avi Epstein, Heidelberg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/467,536

(22) PCT Filed: Feb. 4, 2002
(86) PCT No.: PCT/DE02/00393

(30) Foreign Application Priority Data
Feb. 9, 2001 (DE) 101-06-340.7

(51) Int. Cl. G06F 7/00

(52) U.S. Cl. 707/6

(57) ABSTRACT

A circuit for processing data, comprising a chip (1) consisting of at least two registers (2), configured in such a way as to chronologically optimize the search of a data bank, whereby the rules for searching a data bank comprised of data are filed in the registers (2) and the rules can be processed in a substantially simultaneous manner.

The present invention relates to a circuit for processing data, including a chip having at least two registers.

Circuits for processing data that include a chip having at least two registers are sufficiently well-known. Software for the search of data combined to form a database is also known, in which the data is generally composed of individual characters. This search is generally implemented through the sequential processing of a program with a commonly used computer.

Such a software implementation is particularly problematic to the effect that even in a very rapid clock cycle of the processor, the sequential processing of the required commands of such a program requires a very long total time.

The present invention is based on the task of specifying a circuit for processing data, in which the search of a database is chronologically optimized.

This aforementioned task is achieved according to the present invention through a circuit for processing data having the features of Patent claim 1. Accordingly, the circuit in question for processing data is designed and developed such that rules for the search of data combined to form a database are filed in the registers and that the rules are substantially simultaneously processable.

In a manner according to the present invention, it was initially recognized that, in a departure from previous practice, a search of data combined to form a database need not be implemented through software but that a substantially faster search may be achieved if the search is implemented through hardware. In a further manner according to the present invention, it was then realized that the rules that define the search pattern, according to which the database is supposed to be searched, must be filed in registers, and that the rules must be processable substantially simultaneously and not sequentially, for example. In the process, the type of data involved is irrelevant. For example, the use of the circuit in intelligent search engines for the Internet is conceivable. Indeed, even very different applications are possible, for example in the field of the military industry in collecting and analyzing data. The circuit according to the present invention is certainly suitable in a particularly advantageous manner for use in different areas of molecular biology, for example, in the search for gene motifs or protein sequences. Through the substantially simultaneous processing of the rules, the speed of the search for every single piece of data may be increased considerably.

With regard to a particularly fast search of the data, the rules may be processed within one cycle or several cycles.

With respect to a detection of particularly critical and complex search patterns, the rules may include logical expressions and/or field definitions and/or wildcard functions, in which the wildcard function facilitates the generation of an output signal for every single character. Here, aside from individual characters, the search patterns may also include character combinations, for example, whole words and/or figures. In addition, or alternatively, the rules may also contain regular expression functions. In logical expressions, OR and AND/NOT operations would be particularly simple to implement.

It would be of further advantage if the rules for searching the database were to be filed in encoded form in the registers. The registers may then exhibit a width of 2″-bit. This would make the implementation and detection of complex search patterns particularly simple.

Within the scope of a particularly compact embodiment, the data of the database could be filed in a data storage device. In a particularly simple embodiment, this data storage device could be executed as RAM or FIFO.

In order to make a search of the data particularly simple, at least one data register may be positioned on the chip. Here, the data of the database, preferably from the data storage device, may be pushed into the data register(s), which could be 2″-bit wide in accordance with the number of characters. The data of the database may then be pushed in succession into and/or through the data register.

With respect to a particularly simple, and above all, optimized search, the number of the data register may be the same as the number of the register in which the rules for searching the database are filed, as a result of which, in a particularly simple manner, the processing of all the rules takes place in parallel and within one cycle. The parallelity of the circuit arrangement would then be two-dimensional, as it were. For one thing, a window would be opened up, in which the comparison of all the character or character combination positions of the data segment would be simultaneously facilitated, and, for another, the different characters or character combinations defined by the rules could be detected for each character or character combination position.

With respect to a once again very simple embodiment, the data could be encoded using at least one encoder. In this connection, the data could be encoded into a 2″-bit code using the encoder or the encoders. The encoding of the data to be searched would facilitate a particularly simple comparison between the data and the rules, thereby making possible a particularly fast detection of complex search patterns within one cycle.

With respect to a once again chronologically optimized embodiment, the registers could be comparable with data from the data register(s) using one or several comparator(s). The comparator(s) could then, if necessary, compare the encoded rules and the encoded data bit for bit and, in the event of match, would generate an output signal in one bit. Alternatively, it would also be possible for the comparison of the individual bits to be implemented using AND gates.

Within the scope of a particularly simple embodiment of the chip, one register, one data register, one encoder and one comparator each may be combined to form an individual character element. Alternatively, an individual character element could also exhibit only one register, one data register, and one comparator. An encoder may then be connected to the individual character elements in order to encode the data before they are pushed into the data register.

With regard to a particularly functional arrangement, the individual character elements could be positioned in a parallel connection and preferably also on the chip. This would result in an uncomplicated circuit arrangement since most of the signals cycle through the circuit in a pipeline-like manner. The size of the simultaneously searchable data segment—or of the window in which the comparison of all character positions of the data segment would be simultaneously possible—would then be defined through the number of the individual character elements connected in parallel.

The output signals of the comparators could then be added up using an adder. Because of this, it would be possible to make a statement as to what extent the searched data corresponds to the data being sought.

With respect to a particularly functional embodiment, the adder could be created from cascaded modules, in particularly from adders and/or adder registers. This would facilitate, in a particularly simple manner, adding a plurality of output signals from comparators, in which the number of the characters or character combinations to be compared would not be limited by the physical limitations of an individual adder.

Within the scope of a particularly variable search of the data, the output signal of the adder could be comparable with a threshold value using a component executing a comparing operation, for example, a comparator. The output signal of the adder could in a particularly advantageous manner be an n-bit word. In this connection, the threshold value could be variably specifiable within the scope of a particularly flexible embodiment, and could be configured such that, for instance, it specifies the percentage with which the data searched within the current cycle corresponds to the data sought.

If the threshold value is exceeded, the memory address of the detected data and/or the detected data may be output into a result register using an address pointer. The address pointer would accordingly track down in the data storage device the addresses of the data found in the data registers within the current cycle.

With respect to a possible further processing of the data, the output signal of the adder could be allocated to the address of the detected data in the data storage device and/or to the data and or may be output into the result register. It would consequently even make it possible, for instance, to further limit an already conducted search such that only output signals that exceed a further threshold value are taken into account.

With respect to a particularly user-friendly embodiment, a host computer may be connected to the circuit and/or to the chip using an interface. Using the host computer, the rules for searching the data may then be read into the register and/or the data could be read into the data storage device, for example. Alternatively, or in addition, the address of the detected data and/or the detected data, as well as the output signal of the adder, is retrievable using the host computer. The host computer here could be a standard PC.

With respect to a particularly compact embodiment, the chip and/or the data storage device and/or the address pointer and/or the result register and/or the interface could be positioned on at least one printed circuit board. However, it would also be possible to connect several chips and/or several data storage devices to one another and/or to position these on a printed circuit board. Alternatively hereto, the data storage device and/or the address pointer and/or the result register and/or the interface could also be positioned on the chip.

In order to once again achieve the optimization of the processing speed and to deal with the limitation of the bandwidth of the bus connecting the circuit, the data may be retrieved in parallel from the data storage device. The parallel structure could, in the process, be implemented in the data storage device and/or on the printed circuit board. The data could then be retrieved in parallel, for example, from the data storage device, as a result of which the speed of the retrieval would increase. Using a multiplexer integrated in the data storage device and/or on the chip and/or the printed circuit board, the data may be merged and then pushed into the data register. In this case, the number of input contacts would increase by the parallelity factor but the required bandwidth would diminish by the same factor.

There are now different possibilities for developing and enhancing the teaching of the present invention in an advantageous manner. In this regard, reference is made, with the help of the drawing, to the patent claims subordinate to Patent claim 1 and to the following explanation of preferred exemplary embodiments of the circuit according to the present invention for processing data. In connection with the explanation of the preferred exemplary embodiments of the circuit according to the present invention, with the help of the drawing, preferred embodiments and enhancements of the teaching will also be explained in general. The drawing shows

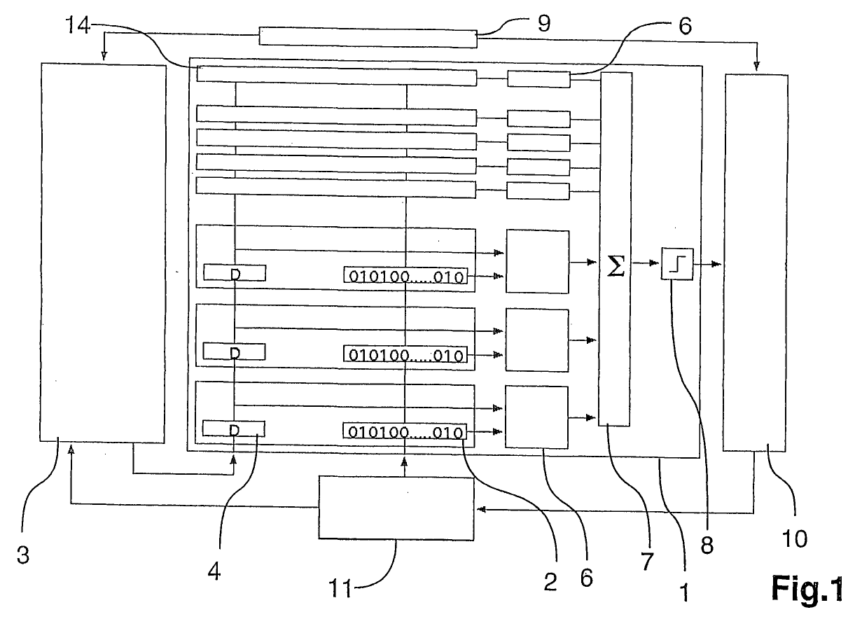

FIG. 1 in a schematic representation, an exemplary embodiment of a circuit according to the present invention for processing data,

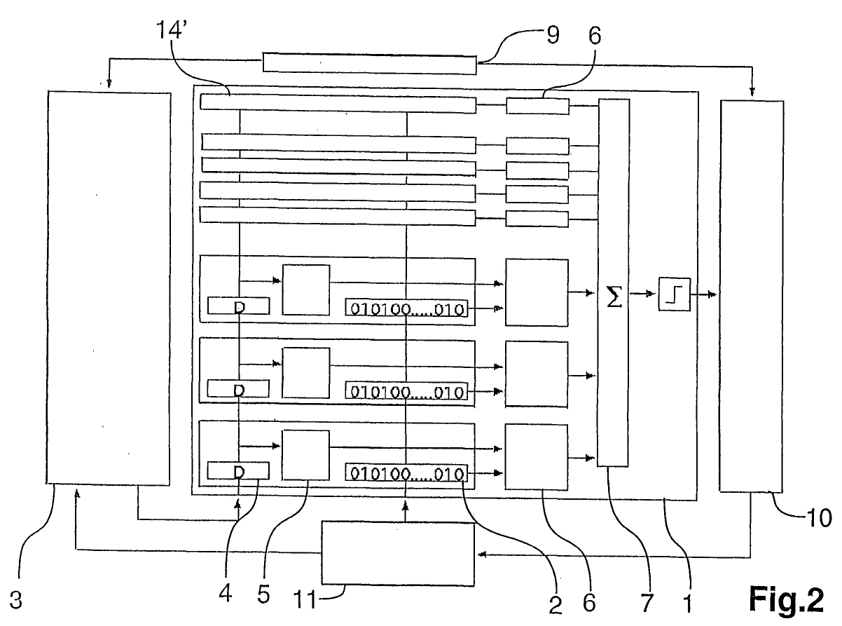

FIG. 2 in a schematic representation, a further exemplary embodiment of a circuit according to the present invention

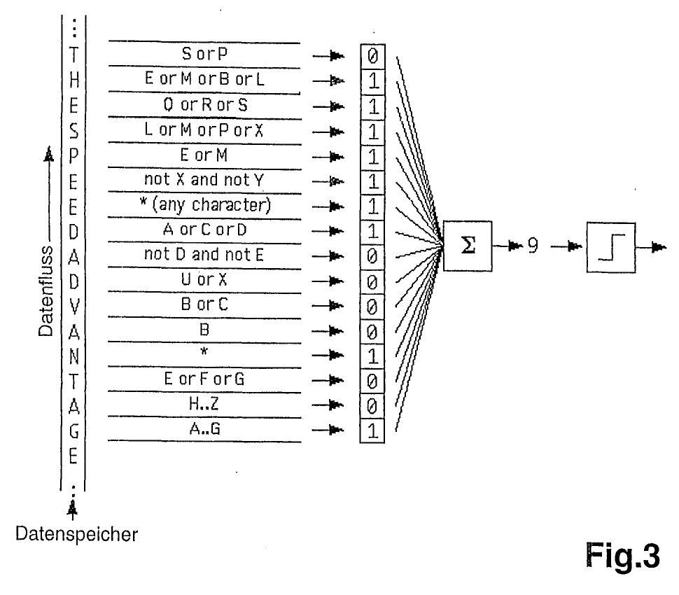

FIG. 3 a schematic representation of the functional sequences in the circuit according to the present invention

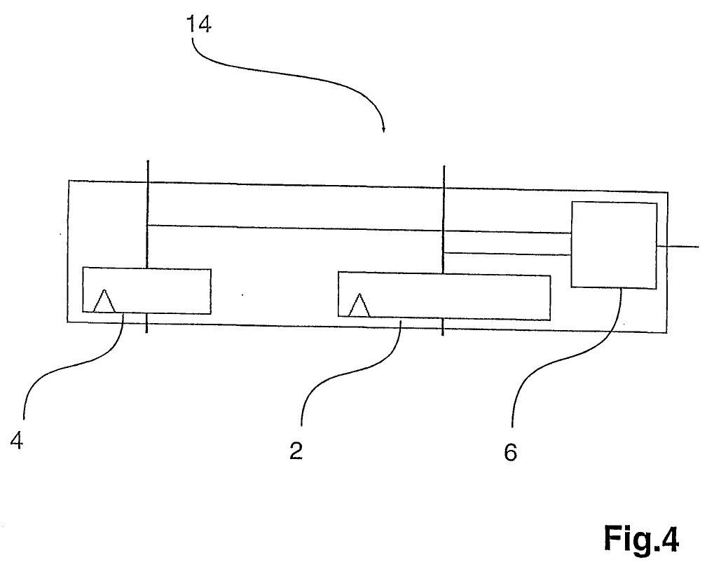

FIG. 4 in a schematic representation, an individual character element of the circuit according to the present invention from FIG. 1,

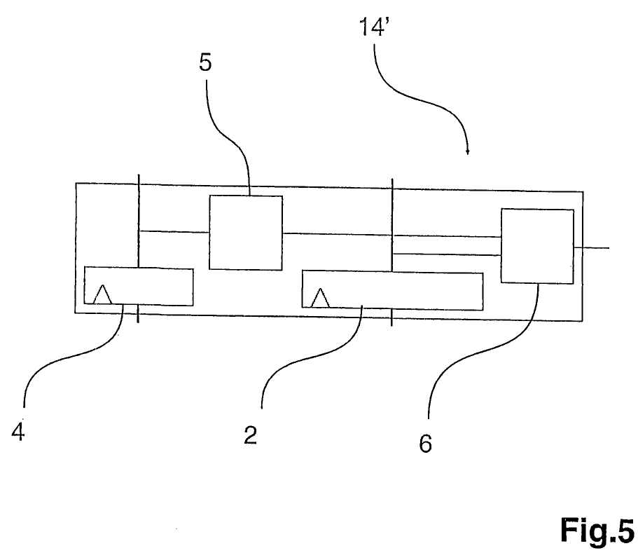

FIG. 5 in a schematic representation, an individual character element of the circuit according to the present invention from FIG. 2, and

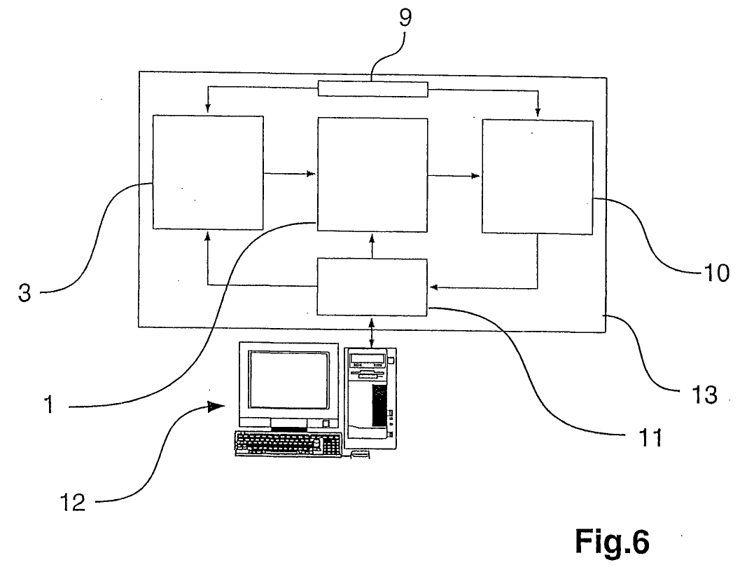

FIG. 6 in a schematic representation, a possible configuration of the circuit according to the present invention.

FIGS. 1 and 2 each show an exemplary embodiment of a circuit for processing data, including a chip 1 with 32 registers 2—not shown completely here.

In a manner according to the present invention, rules for searching data combined to form a database are filed in registers 2 and the rules are simultaneously processable.

The rules defining the search pattern are, in the exemplary embodiments, logical expressions as well as field definitions and wildcard functions. In this exemplary embodiment, the logical expressions include OR operations and AND-NOT operations. The rules for searching the database are filed in encoded form in registers 2, in which the code shown in FIGS. 1 and 2 correspond to the logical expression “B or W or Y”.

The data of the database is filed in a data storage device 3. Data storage device 3 is executed as RAM in the exemplary embodiments.

Data registers 4 are positioned on chip 1, in which the data of the database can be pushed from data storage device 3. The number of data registers 4 is the same as the number of registers 2 in which the rules for searching the data are filed. This means that 32 character-long data records may be compared per cycle with the rules.

In the exemplary embodiment of FIG. 2, the data is encoded using encoder 5. This involves n/2″ encoders, which encode the data into an n-bit code. The data will then be compared bit for bit with the rules in registers 2 using comparators 6 and an output signal is generated in the event of a match.

In each case, one register 2, one data register 4, one comparator 6, and in the exemplary embodiment of FIG. 2, one encoder 5, are combined to form an individual character element 14, 14′. The individual character elements 14, 14′ are connected in parallel, and moreover, positioned parallel to each another on chip 1.

The output signals of comparators 6 are added up using an adder 7 and the output signal of adder 7—in this case a 4-bit word—is compared with a threshold value using a component 8 executing a comparing operation. The threshold value gives the possibility of making an assessment as to the extent that the data should correspond to the data sought, and is variably specifiable by a user.

If the threshold value is exceeded, the address of the detected data in data storage device 3 is filed using an address pointer 9 in a result register 10.

The functional sequences of the circuit are illustrated in FIG. 3. The searching of the data takes place through successive pushing of the data through the data register and comparing the data with the search pattern specified by the rules. The output signal of the comparators shows whether the character examined matches the rule. The sum of the output signals is a measure of the conformity of the data searched with the data sought, since it shows how many characters match the search pattern. If the matches vary in degree, a trigger signal for storing the address of the detected data may be generated through a comparison with a variable threshold value.

FIGS. 4 and 5 schematically show the structure of an individual character element 14, 14′ of the exemplary embodiments of FIG. 1 and of FIG. 2. In individual character elements 14, 14′, one register 2, one data register 4, as well as one comparator 6 are combined, while one encoder 5 is combined in the exemplary embodiment of FIG. 2. The individual character elements 14, 14′ are positioned in parallel and connected in parallel to each other on chip 1.

FIG. 6 shows a printed circuit board, on 13, on which chip 1, data storage device 3 and an interface 10 are positioned. A host computer 12—here a standard PC—may be connected to the circuit using interface 11. Using host computer 12, the rules for searching the data are initially read into register 2 and then the data into data storage device 3. In addition, using host computer 12, the threshold value is specified and the address of the detected data is retrieved from result register 10, and the detected data is retrieved from data storage device 3.

With respect to other details, reference is made to the general description to avoid repetitions.

Finally, it should be expressly indicated that the aforementioned described exemplary embodiments serve only to discuss the claimed teaching in detail, but that these are not restricted to the exemplary embodiments.

1. A circuit for processing data, including a chip (1) having at least two registers (2), wherein rules for searching data combined to form a database are filed in the registers (2) and the rules are substantially simultaneously processable.

2. The circuit as recited in claim 1, wherein the rules are may be processed within one cycle or several cycles.

3. The circuit as recited in claim 1 or 2, wherein the rules include logical expressions and/or field definitions and/or wildcards.

4. The circuit as recited in claim 3, wherein the logical expressions include OR operations and/or AND operations and/or NOT operations.

5. The circuit as recited in one of claims 1 to 4, wherein the rules for searching the database are filed in encoded form in the registers (2).

6. The circuit as recited in one of claims 1 to 5, wherein the data of the database is filed in a data storage device (3).

7. The circuit as recited in claim 6, wherein the data storage device (3) is executed as RAM or FIFO.

8. The circuit as recited in one of claims 1 to 7, wherein at least one data register (4) is positioned on the chip (1).

9. The circuit as recited in claim 8, wherein the data of the database, preferably from the data storage device (3), may be pushed into the data register(s) (4).

10. The circuit as recited in claim 8 or 9, wherein the number of data registers (4) is the same as the number of registers (2) in which the rules for searching the database are stored.

11. The circuit as recited in one of claims 1 to 10, wherein the data could be encoded using at least one encoder (5).

12. The circuit as recited in claim 11, wherein the data could be encoded into an n-bit code using the encoder or the encoders (5).

13. The circuit as recited in claim 8, if necessary, and in one of claims 8 to 12, wherein the rules in the registers (2) are comparable using one or several comparator(s) (6) with the data from the data register(s) (4).

14. The circuit as recited in one of claims 8 to 10 and claim 11 or 12 and claim 13, if necessary, wherein one register (2), one data register (4), if necessary one encoder (5) and one comparator (6), are combined to form an individual character element (14, 14′).

15. The circuit as recited in claim 14, wherein several individual character elements (14, 14′) are positioned in parallel and/or parallel to each other on the chip (1).

16. The circuit as recited in one of claims 13 to 15, wherein the output signals of the comparators (6) may be added up using an adder (7).

17. The circuit as recited in claim 16, wherein the adder (7) is created from cascaded modules, in particular from adders and/or adder registers.

18. The circuit as recited in claim 16 or 17, wherein the output signal of the adder (7) is comparable with a threshold using a component (8) executing a comparing operation.

19. The circuit as recited in claim 18, wherein the threshold value is variably specifiable.

20. The circuit as recited in claim 18 or 19, wherein if the threshold value is exceeded, the address of the detected data in the data storage device (3) and/or the detected data may be output into a result register (10) using an address pointer.

21. The circuit as recited in claim 20, wherein the output signal of the adder (7) may be allocated to the address of the detected data in the data storage device (3) and/or to the detected data and/or may be output into the result register (10).

22. The circuit as recited in one of claims 1 to 21, wherein a host computer (12) may be connected to the circuit and/or to the chip (1) using an interface (11).

23. The circuit as recited in claim 22, wherein the rules for searching the data may be read into the register (2) using the host computer (12).

24. The circuit as recited in claim 22 or 23, wherein the address of the detected data in the data storage device (3) and/or the detected data is retrievable using the host computer (12).

25. The circuit as recited in one of claims 1 and 24, and if necessary, claim 6, and if necessary, claim 20 or 21, and if necessary, one of claims 22 to 24, wherein the chip (1) and/or the data storage device (3) and/or the address pointer (9) and/or the result register (10) and/or the interface (11) is or are positioned on at least one printed circuit board (13).

26. The circuit as recited in one of claims 1 to 25, and if necessary, claim 6, and if necessary, claim 20 or 21, and if necessary, one of claims 22 to 25, wherein the data storage device (3) and/or the address pointer (9) and/or the result register (10) and/or the interface (11) is or are positioned on the chip (13).

27. The circuit as recited in one of claims 1 to 26, and if necessary, claim 6, wherein the data may be retrieved in parallel from the data storage device (3).

28. The circuit as recited in claim 27, and if necessary, claim 25, wherein a parallel structure is implemented in the data storage device (3) and/or on the printed circuit board (13).

29. The circuit as recited in claim 27 or 28, and if necessary, claim 25, wherein the data may be merged using a multiplexer integrated in the data storage device (3) and/or on the chip (1) and/or the printed circuit board (13).
